(19) United States
(12) Patent Application Publication
(10) Pub. No.: US 2018/0257477 A1
(43) Pub. Date: Sep. 13, 2018

(54) TRACTION MANAGEMENT CONTROL SYSTEM FOR VEHICLE HAVING INDEPENDENTLY DRIVEN AXLES

(71) Applicant: GM GLOBAL TECHNOLOGY OPERATIONS LLC, Detroit, MI (US)

(72) Inventors: Eric E. KRUEGER, Milford, MI (US); Xiaofeng MAO, Milford, MI (US); Kevin A. O'DEA, Milford, MI (US)

(21) Appl. No.: 15/758,211

(22) PCT Filed: Sep. 9, 2016
(86) PCT No.: PCT/US2016/050858

§ 371 Date: Mar. 7, 2018

Related U.S. Application Data
(60) Provisional application No. 62/217,845, filed on Sep. 12, 2015.

(51) Int. Cl. B60K 6/52; B60W 10/08; B60K 17/356; B60W 10/06; B60W 20/19

(52) U.S. Cl. CPC B60K 6/52; B60W 10/08; B60K 17/356; B60W 10/06; B60W 20/19; B60L 2240/423; B60K 23/0808; B60W 2540/10; B60W 2520/14; B60W 2710/0666; B60W 2710/083; B60W 2720/403; B60W 2520/263; B60T 2270/303

(57) ABSTRACT

A vehicle includes a first axle system operatively connected to a first set of wheels, a second axle system operatively connected to a second set of wheels, a first drive system operatively connected to the first set of wheels, a second drive system operatively connected to the second set of wheels independent of the first set of wheels, and a traction management control module electrically coupled to at least one of the first and second drive systems. The traction management control module calculates a torque capability of the corresponding one of the first and second axle systems and selectively transmits an axle torque command to the corresponding one of the first and second axle systems based on the torque capability.

### CROSS REFERENCE TO RELATED APPLICATIONS

This application claims priority to U.S. Provisional Patent Application No. 62/217,845, which was filed on Sep. 12, 2015. The entire contents of U.S. Provisional Patent Application No. 62/217,845 are incorporated herein by reference.

### FIELD OF THE INVENTION

The subject invention relates to the art of motor vehicles and, more particularly, to a traction management control system for a motor vehicle having independently driven axles.

### BACKGROUND

Various models of motor vehicles include multi-wheel drive systems. In certain cases, a motor vehicle may have an all or four-wheel drive system (AWD or 4WD). Such vehicles typically include one or more gear boxes that couple all four wheels to a single power source. Occasionally, torque at one or more wheels of an AWD system may be different from others of the wheels. For example, a vehicle driving on ice may experience more or less torque on one or more wheels. Similarly, a vehicle engaged in a turning maneuver may experience torque variations on one or more wheels. Certain vehicles may be provided with a traction control system that operates to modify operations to better establish a desired torque distribution that meets traction requirements for all four wheels.

Some more modern vehicles include hybrid systems having an electric drive component and a fuel driven component. In such vehicles, the electric drive component may be coupled to one axle and the fuel driven component may be coupled to another axle. Given power disparities that may occur between the electric drive component and the fuel driven component, it may be difficult to establish a desired torque distribution to all four wheels to meet traction requirements in various driving conditions. For example, a depleted battery may not be able to produce enough torque to drive an axle coupled to the electric drive component that compliments torque output to axles driven by the fuel driven component under certain driving conditions. Accordingly, it is desirable to provide a traction control system for a motor vehicle having independently driven axles.

### SUMMARY OF THE INVENTION

In accordance with an aspect of an exemplary embodiment, a vehicle includes a first axle system operatively connected to a first set of wheels, a second axle system operatively connected to a second set of wheels, a first drive system operatively connected to the first set of wheels, a second drive system operatively connected to the second set of wheels independent of the first set of wheels, and a traction management control module electrically coupled to at least one of the first and second drive systems. The traction management control module calculates a torque capability of the corresponding one of the first and second axle systems and selectively transmits an axle torque command to the corresponding one of the first and second axle systems based on the torque capability.

In accordance with another aspect of an exemplary embodiment, a method of selectively adjusting torque to at least one of a first axle system connected to a first drive system and second axle system connected to a second drive system independent of the first drive system includes calculating a first torque capability of at least one of first and second wheels associated with the first axle system, calculating a second torque capability of at least one of first and second wheels associated with the second axle system, calculating a wheel slip error and yaw rate error for the at least one of the first and second wheels associated with the first axle system and the at least one of the first and second wheels associated with the second axle system, establishing a first adjusted torque capability and a second adjusted torque capability based on the wheel slip error and yaw rate error of corresponding ones of the first and second wheels associated with the first axle system and the first and second wheels associated with the second axle system, and dynamically distributing a driver desired torque to each of the first and second axle systems based on at least one of the first and second adjusted torque capabilities.

In accordance with yet another aspect of an exemplary embodiment, a vehicle includes a first axle system operatively connected to a first set of wheels, a second axle system operatively connected to a second set of wheels, a first drive system operatively connected to the first set of wheels, a second drive system operatively connected to the second set of wheels independent of the first set of wheels, and a traction management control module electrically coupled to at least one of the first and second drive systems. The traction management control module calculates a torque capability of a corresponding one of the first and second axle systems and selectively transmits an axle torque command to a corresponding one of the first and second axle systems based on the torque capability. The traction management control module establishes a first adjusted torque capability and a second adjusted torque capability based on a wheel slip error and a yaw rate error of corresponding ones of the first set of wheels associated with the first axle system and the second set of wheels associated with the second axle system.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a top schematic view of a vehicle having independently driven axles and a traction management control system, in accordance with an exemplary embodiment;

FIG. 2 is a block diagram illustrating a traction management control system, in accordance with an exemplary embodiment;

FIG. 3 is a flow chart illustrating a method of dynamically distributing axle torque, in accordance with an aspect of an exemplary embodiment;

FIG. 4 is a flow chart illustrating a method of dynamically distributing axle torque, in accordance with another aspect of an exemplary embodiment;

FIG. 5 is a graph illustrating torque distribution options, in accordance with an aspect of an exemplary embodiment; and

FIG. 6 is a graph illustrating torque distribution options, in accordance with another aspect of an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term “module” or “unit” refers to an application specific integrated circuit (ASIC), a field programmable gate array (FPGA), an electronic circuit, an electronic computer processor (shared, dedicated, or group) and memory that executes one or more software or firmware programs, a hardware microcontroller, a combinational logic circuit, and/or other suitable components that provide the described functionality. When implemented in software, a module can be embodied in memory as a non-transitory machine-readable storage medium readable by a processing circuit and storing instructions for execution by the processing circuit for performing a method.

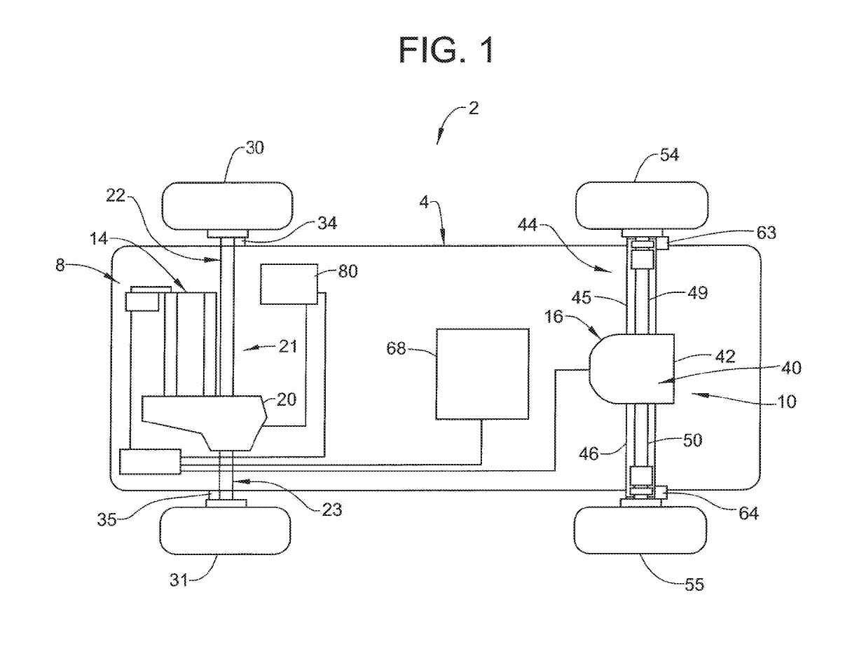

A motor vehicle, in accordance with an exemplary embodiment, is indicated generally at 2, in FIG. 1. Vehicle 2 includes a chassis 4 that supports a first drive system 8 and a second drive system 10. First drive system 8 may take the form of an internal combustion engine 14 and second drive system 10 may take the form of an electric motor or eDrive system 16. First drive system 8 is operatively connected to a transmission 20. Transmission 20 is operatively connected to a first or front axle system 21 having a first front axle 22 and a second front axle 23. First front axle 22 supports a first front wheel 30 and second front axle 23 supports a second front wheel 31. In accordance with an aspect of an exemplary embodiment, a first sensor 34 may be arranged at first front axle 22 adjacent first front wheel 30 and a second sensor 35 may be arranged at second front axle 23 at second front wheel 31. First and second sensors 34 and 35 may detect slip and/or yaw rate associated with each front wheel 30 and 31.

In further accordance with an exemplary embodiment, eDrive system 16 may include an eAxle 40 having a housing 42. eAxle 40 is operatively coupled to a second or rear axle system 44. More specifically, a first axle tube 45 may extend from eAxle 40 in a first direction and a second axle tube 46 may extend from eAxle 40 in a second direction. Second axle system 44 may include a first rear axle 49 extending through a first axle tube 45 and a second rear axle 50 extending through a second axle tube 46. First rear axle 49 supports a first rear wheel 54 and second rear axle 50 supports a second rear wheel 55. In accordance with an aspect of an exemplary embodiment, a first sensor 63 may be arranged at first rear axle 49 adjacent first rear wheel 54 and a second sensor 64 may be arranged at second rear axle 50 at second rear wheel 55. First and second sensors 63 and 64 may detect slip and/or yaw rate associated with each rear wheel 54 and 55. Vehicle 2 may also include a battery 68 operatively connected to eAxle 40 through a power control module 70. Power control module 70 selectively delivers power to eAxle 40 to establish a desired output at first and second rear wheels 54 and 55.

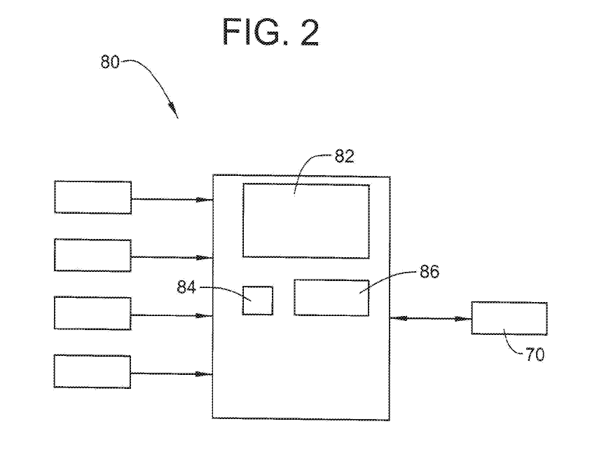

In accordance with an aspect of an exemplary embodiment, vehicle 2 includes a traction management control module 80 that selectively distributes torque to each of first and second axle systems 21 and 44 based on driving conditions, driver demand, and a torque capability of one of more of first and second front wheels 30, 31 and first and second rear wheels 54, 55. As shown in FIG. 2, traction management control module 80 includes a central processing unit (CPU) 82 operatively connected to a traction management module 84 and a memory 86. Memory 86 may store a set of instructions, which, as will be detailed more fully below, may provide a set of instructions to traction management control module 80 to selectively distribute torque to each of first and second axle systems 21 and 44.

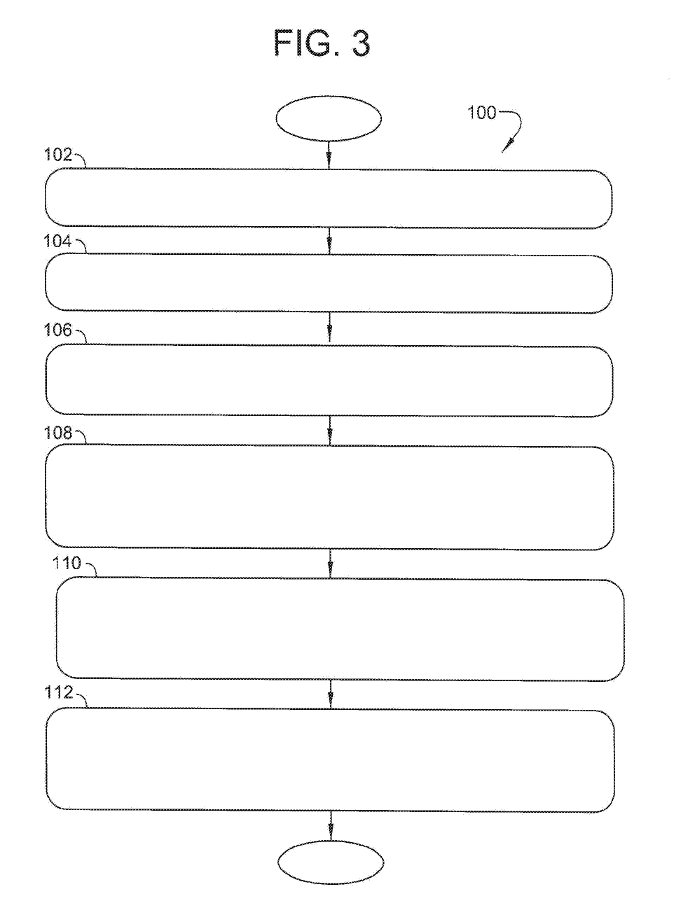

Reference will now follow to FIG. 3 in describing a method 100 of distributing a drive desired torque while maintaining, as much as practical, a sporty driving mode. In block 102, a minimum torque capability (Fz, Fy, and Fx) for one or more of first and second front wheels 30, 31 and first and second rear wheels 54, 55 is calculated wherein Fx=sqrt(Fẑ2-Fŷ2) and wherein Fx_frt=min (Fx_LF, Fx_RF) and Fx_rr=min(Fx_LR, Fx_RR). The term “capability” should be understood to include the capability of the drive system to deliver the desired torque, and also the capability of the tire/wheel to support the distributed torque.

In block 104, a mean torque capability for one or more of first and second front wheels 30, 31 (M_frt) and first and second rear wheels 54, 55 (M_rr) may be calculated for vehicle 2 provided with an electronic limited slip differential (eLSD), wherein M_frt=2*Fx_frt*R_frt+M_frt_elsd and M_rr=2*Fx_rr*R_rr+M_rr_elsd. In block 106, a wheel slip and yaw rate (YR) error is calculated, wherein YR_err=|DYR|−|YR|; WSL_frt=max (WS_LF-WRS_LF, WS_RF-WRS_RF)-Thrd1; WSL_rr=max (WS_LR-WRS_LR, WS_RR-WRS_RR)-Thrd2. In block 108 torque capability for one or more of first and second front wheels 30, 31 (M_frt_md) and first and second rear wheels 54, 55 (M_rr_md) is dynamically adjusted based on wheel slip and yaw rate error, wherein M_frt_md=M_frt-Cal1*YR_err-Cal2*WSL_frt+Cal3*WSL_rr, and M_rr_md=M_rr+Cal4*YR_err+Cal5*WSL_frt-Cal6*WSL_rr.

In block 110, a torque command is sent to transmission 20 and/or eAxle 40 to distribute a driver desired torque to one or more of first and second axle systems 21 and 44 to achieve a sporty feeling, wherein Front axle torque command=DDAT*M_frt_md/(M_frt_md+M_rr_md) and rear axle torque command=DDAT*M_rr_md/(M_frt_md+M_rr_md). In block 112, the torque command may be limited within a non-slip region based on Friction Circle Theory. In this manner, the driver desired torque, based on driving speed, cornering speed, and the like, may be maintained as much as possible without sacrificing a sporty ride. It is to be understood that DDAT=Driver-desired axle torque; DYR=Desired yaw rate; YR=Yaw rate; WSL=Wheel Slip; WS=Wheel speed; and WRS=Wheel reference speed. All Cals and Thrds are based on look up tables associated with vehicle motion status.

In accordance with an aspect of an exemplary embodiment, if a tire cannot support the torque being delivered to it (such as may be determined by estimating the capability of each tire based on empirical tire data and knowledge of a road surface, and an amount of torque being delivered), then the torque can be redistributed to the other axle. In the case that there is a controllable torque separation device on one or both axles (electronically limited slip differential, for example), the torque can be redistributed to the wheel on that same axle. Further, redistributing torque may be particularly advantageous in the case of an electric axle not having an ability to deliver a desired and/or demanded amount of torque.

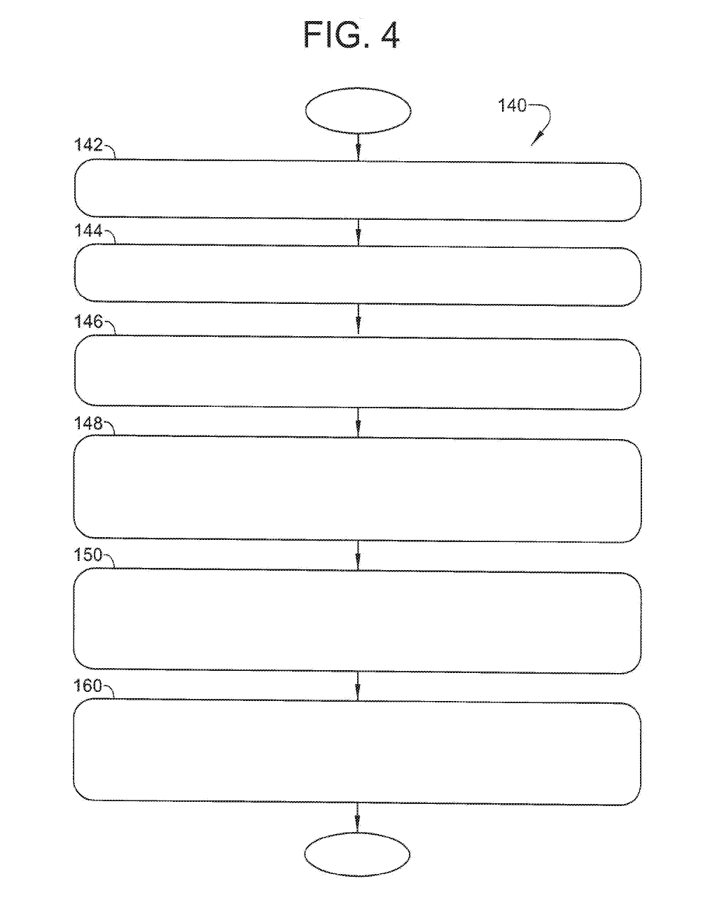

FIG. 4 describes a method 140 of distributing a drive desired torque in real-time. In block 142, a minimum torque capability (Fz, Fy, and Fx) for one or more of first and second front wheels 30, 31 and first and second rear wheels 54, 55 is calculated wherein Fx=sqrt(Fẑ2-Fŷ2) and wherein Fx_frt=min (Fx_LF, Fx_RF) and Fx_rr=min(Fx_LR, FX_RR). In block 144, a mean torque capability (M_frt, M_rr) for one or more of first and second front wheels 30, 31 and first and second rear wheels 54, 55 may be calculated for vehicle 2 provided with an electronic limited slip differential (eLSD) wherein M_frt=2*Fx_frt*R_frt+M_frt_elsd and M_rr=2*Fx_rr*R_rr+M_rr_elsd.

In block 146, a torque command (M_frt_md, M_rr_md) is sent to transmission 20 and/or eAxle 40 to distribute a driver desired torque between one or more of first and second front wheels 30, 31 and first and second rear wheels 54, 55 in proportion to axle torque capability, wherein M_frt_md=DDAT*M_frt/(M_frt+M_rr) and M_rr_md=DDAT*M_rr/M_frt+M_rr). In block 148 wheel slip and yaw rate error (YR_err) is calculated, wherein YR_err=|DYR|−|YR|; WSL_frt=max (WS_LF-WRS_LF, WS_RF-WRS_RF)-Thrd1; WSL_rr=max (WS_LR-WRS_LR, WS_RR-WRS_RR)-Thrd2. In block 150 torque command to the front axle M_frt_md-Cal1*YR_err-Cal2*WSL_frt+Cal3*WSL_rr is calculated and torque command to the rear axle M_rr_md+Cal4*YR_err+Cal5*WSL_frt-Cal6*WSL-rr is calculated for one or more of first and second front wheels 30, 31 and first and second rear wheels 54, 55 is dynamically adjusted based on wheel slip and yaw rate error. In block 160, the torque command may be limited within a non-slip region based on Friction Circle Theory.

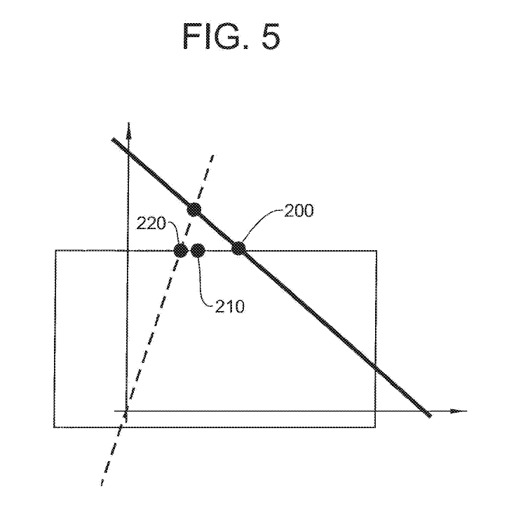

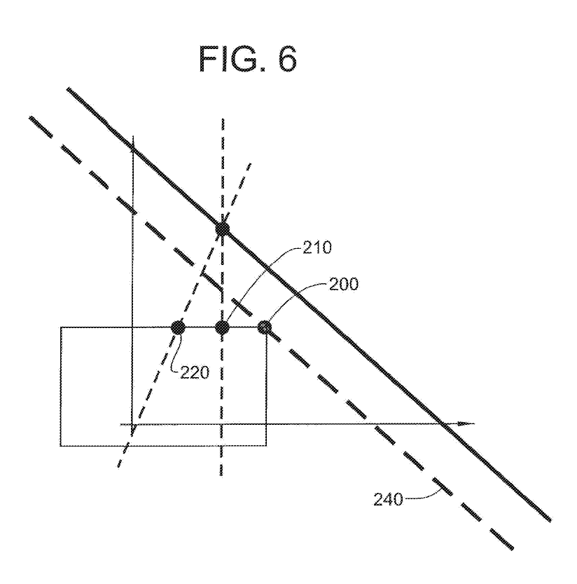

At this point, it should be understood that the exemplary embodiments describe a system for controlling traction in one or more drive wheels connected to independently powered axles. The system balances driver desired torque with available torque to provide a sportier ride, as shown at 200 in FIG. 5. Alternatively, the system may limit axle torque commands by axle capability, as shown at 210 in FIG. 5. Further, the system may simply maintain a torque split ratio as shown at 220 in FIG. 5. FIG. 6 illustrates traction control scenarios when a driver demands too much torque identified by a dotted line 240. In addition, it should be understood that, in order to deliver the driver's requested torque (from the accelerator pedal), it may be desirable to rebalance torque between the axles if one or more tires are spinning or slipping. For example, if the driver is turning and accelerating, the vehicle will pitch backward and roll. In this case, the inside front wheel will get light and may not be able to support the torque delivered to it. In such a scenario, torque may be rebalanced by shifting torque to the rear axle, which is heavier and can support more propulsion torque. Further, in the event that a driver desired axle torque exceeds a sum of maximum front axle torque capability and the maximum rear axle torque capability, the a traction management control module may limit the distributed torque to maintain delivered torque to the torque capability of each axle.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A vehicle comprising:
a first axle system operatively connected to a first set of wheels; a second axle system operatively connected to a second set of wheels; a first drive system operatively connected to the first set of wheels; a second drive system operatively connected to the second set of wheels independent of the first set of wheels; and
a traction management control module electrically coupled to at least one of the first and second drive systems, the traction management control module calculating a torque capability of a corresponding one of the first and second axle systems and selectively transmitting an axle torque command to a corresponding one of the first and second axle systems based on the torque capability.

2. The vehicle according to claim 1, wherein the first drive system comprises an internal combustion engine.

3. The vehicle according to claim 1, wherein the second drive system comprises an electric motor.

4. The vehicle according to claim 1, further comprising: at least one first sensor coupled to the first axle system and operatively connected to the traction management control module.

5. The vehicle according to claim 4, further comprising: at least one second sensor coupled to the second axle system and operatively connected to the traction management control module.

6. The vehicle according to claim 1, wherein the traction management control module establishes a first adjusted torque capability and a second adjusted torque capability based on a wheel slip error and a yaw rate error of corresponding ones of the first set of wheels associated with the first axle system and the second set of wheels associated with the second axle system.

7. A method of selectively adjusting torque to at least one of a first axle system connected to a first drive system and second axle system connected to a second drive system independent of the first drive system, the method comprising:
calculating a first torque capability of at least one of first and second wheels associated with the first axle system;
calculating a second torque capability of at least one of first and second wheels associated with the second axle system;
calculating a wheel slip error and yaw rate error for the at least one of the first and second wheels associated with the first axle system and the at least one of the first and second wheels associated with the second axle system;
establishing a first adjusted torque capability and a second adjusted torque capability based on the wheel slip error and yaw rate error of corresponding ones of the first and second wheels associated with the first axle system and the first and second wheels associated with the second axle system; and
dynamically distributing a driver desired torque to each of the first and second axle systems based on at least one of the first and second adjusted torque capabilities.

8. A vehicle comprising:
a first axle system operatively connected to a first set of wheels; a second axle system operatively connected to a second set of wheels; a first drive system operatively connected to the first set of wheels; a second drive system operatively connected to the second set of wheels independent of the first set of wheels; and
a traction management control module electrically coupled to at least one of the first and second drive systems, the traction management control module calculating a torque capability of a corresponding one of the first and second axle systems and selectively transmitting an axle torque command to a corresponding one of the first and second axle systems based on the torque capability, wherein the traction management control module establishes a first adjusted torque capability and a second adjusted torque capability based on a wheel slip error and a yaw rate error of corresponding ones of the first set of wheels associated with the first axle system and the second set of wheels associated with the second axle system.
